(19) United States
(12) Patent Application Publication
(10) Pub. No.: US 2023/0376846 A1
(43) Pub. Date: Nov. 23, 2023

(54) INFORMATION PROCESSING APPARATUS AND MACHINE LEARNING METHOD

(71) Applicants: Fujitsu Limited, Kawasaki-shi (JP); INDIAN INSTITUTE OF SCIENCE, Bengaluru (IN)

(72) Inventors: Sho TAKEMORI, Yokohama (JP); Takashi KATOH, Kawasaki (JP); Yuhei UMEDA, Kawasaki (JP); Harsh RANGWANI, Ajmer (IN); Shrinivas RAMASUBRAMANIAN, New Delhi (IN); Venkatesh Babu RADHAKRISHNAN, Bangalore (IN)

(73) Assignees: Fujitsu Limited, Kawasaki-shi (JP); INDIAN INSTITUTE OF SCIENCE, Bengaluru (IN)

(21) Appl. No.: 18/199,443

(22) Filed: May 19, 2023

(30) Foreign Application Priority Data
May 19, 2022 (IN) 202231028920

(51) Int. Cl. G06N 20/00; G06F 17/16

(52) U.S. Cl. CPC G06N 20/00; G06F 17/16

(57) ABSTRACT

An information processing apparatus includes one or more memories; and one or more processors coupled to the one or more memories, the one or more processors being configured to decide a gain matrix based on an input metric, perform selection of first training data from a plurality of unlabeled training data, to be used for training a machine learning model, based on the gain matrix, and perform training of the machine learning model based on the first training data, a predicted label that is predicted from the first training data, and a loss function including the gain matrix.

### CROSS-REFERENCE TO RELATED APPLICATION(S)

This application is based upon and claims the benefit of priority of the prior India Provisional Application No. 202231028920, filed on May 19, 2022, the entire contents of which are incorporated herein by reference.

### FIELD

The embodiment discussed herein is related to machine learning technology.

### BACKGROUND

There has been a tendency that, in a case where machine learning algorithm is applied to abnormality detection and medical image diagnosis so as to train a classifier (machine learning model) by using a training data set, the training data set becomes a data set with class imbalance. For example, in a case where training of a classifier for abnormality detection is executed, non-abnormality labels are provided for most of the training data sets. In a case where training of a classifier for medical diagnosis is executed, non-abnormality labels are also widely provided for training data sets.

In a case where training of a classifier is executed by using a training data set with class imbalance, it is difficult to appropriately evaluate the performance of machine learning algorithm depending on only the accuracy of the classifier, and thus a more complicated metric (index) is used in some cases. The more complicated metric is, for example, an metric that is not suitable for optimization by using cross entropy often used as a loss function.

Hereinafter, a conventional technology 1 and a conventional technology 2 will be explained.

First, a basic metric used in the conventional technology 1 will be explained. A classifier is defined as “F: X→(K)”. Note that “X” indicates a space of an input. Note that (K)={1, . . . , K} is a set of labels.

A K-by-K confusion matrix C(F) is defined as indicated in formula (1). In formula (1), “D” indicates a distribution of data. In formula (1), “1” is an indicator function. In a case where “y=i, F(x)=j” is satisfied in the indicator function, a value of the indicator function is “1”, and in a case where “y=i, F(x)=j” is not satisfied, a value of the indicator function is “0”. Note that “E” in formula (1) corresponds to calculation for an expectation value.

Cᵢⱼ(F)=E_{(x,y)˜D}(1(y=i, F(x)=j)) . . . (1)

A class distribution is defined by formula (2) for each “i”.

πᵢ=P(y=i) . . . (2)

An accuracy acc(F) of a classifier is defined by formula (3). For example, the accuracy corresponds to a proportion of the number of correctly-answered data to all data that are input to a classifier.

acc(F)=Σₖ₌₁^{K}Cₖₖ(F) . . . (3)

A recall recᵢ(F) for each class of a classifier is defined by formula (4). The recall corresponds to a proportion of actually determined data to data to be determined. For example, the recall indicates how many classifiers, among a plurality of data that are to be classified into a first class, are classified into the first class.

recᵢ(F)=Cᵢᵢ(F)/P(y=i) . . . (4)

A precision precᵢ(F) for each class of a classifier is defined by formula (5). The precision corresponds to a proportion of actually correct answers to the number of determination counts of “data to be determined”. For example, the precision is a proportion of data to be actually classified into a first class to a plurality of data having been classified into the first class by a classifier.

precᵢ(F)=Cᵢᵢ(F)/Σₖ₌₁^{K}Cₖᵢ(F) . . . (5)

A proportion estimated to be a class i by a classifier is defined as a coverage. A coverage covi(F) is defined by formula (6).

covᵢ(F)=Σₖ₌₁^{K}Cₖᵢ(F) . . . (6)

Herein, the worst recall is defined by formula (7). The worst recall is an metric that is useful for a data set with class imbalance.

$${min}_{1 \leq i \leq K} {rec}_{i} ( F ) \qquad ( 7 )$$

Similarly, in a case where a data set is a data set with class imbalance, a problem is that estimation of a classifier is biased toward a specific class, and hence, optimization under a coverage constraint is important. Formula (8) is one example of an metric for executing optimization on an average recall under a coverage constraint. For example, formula (8) is an metric for maximizing a total value of recalls of classes 1 to K under a condition that a coverage is equal to or more than “0.95×πᵢ”.

$${max}_{F} \frac{1}{K} {\sum }_{i = 1}^{K} {rec}_{i} ( F ) subject to {cov}_{i} ( F ) \geq 0.95 {π}_{i} , ∀ i \qquad ( 8 )$$

Moreover, an metric for executing optimization under a constraint related to a precision is also provided, and is indicated by formula (9). For example, formula (9) is an metric for maximizing an accuracy acc(F) under a condition that a precision is equal to or more than “τ (threshold)”.

$${max}_{F} acc ( F ) subject to {prec}_{i} ( F ) \geq τ , ∀ i \qquad ( 9 )$$

An metric where optimization is difficult as explained in formulae (7), (8) and (9) as mentioned above and the like leads to cost-sensitive learning. The cost-sensitive learning is indicated by formula (10). In the cost-sensitive learning, maximization is sought by using a gain matrix G (gain Matrix).

$${max}_{F} {\sum }_{i , j = 1}^{K} {G}_{ij} {C}_{ij} ( F ) \qquad ( 10 )$$

For example, the worst recall is indicated as formula (11) by continuous relaxation. In formula (11), Δ_{K-1}⊂R^{K} is a probability simplex. For example, “Δ_{K-1}” indicates a set of K-dimensional vectors where each component has a positive value and a total of values of the components is one. In the worst recall, a gain matrix G is given by formula (12). In formula (12), “δ” is Kronecker delta.

$${max}_{F} {min}_{λ ∈ {Δ}_{K - 1}} {\sum }_{k = 1}^{K} {λ}_{k} {C}_{kk} ( F ) / {π}_{k} \qquad ( 11 )$$

$${G}_{ij} = \frac{{δ}_{ij}}{{π}_{i}} {λ}_{i} \qquad ( 12 )$$

With respect to a coverage constraint, a gain matrix G is given by formula (13) with a Lagrange factor λ ∈ R^{K}. With respect to λᵢ in formula (13), λⱼ≥0 is satisfied for all “j”.

$${G}_{ij} = \frac{{δ}_{ij}}{K {π}_{i}} {λ}_{j} \qquad ( 13 )$$

Learning of λ and cost-sensitive learning are alternately repeated so as to execute learning for an original metric. The original metric is the worst recall, an average recall under a coverage constraint, and the like.

Herein, a cross-entropy loss function used in a general machine learning is not appropriate for the cost-sensitive learning, and hence, the conventional technology 1 proposes a loss function for cost-sensitive learning.

For example, a gain matrix G is decomposed as “G=MD”. “M” and “D” are K-by-K matrices, and “D” is a diagonal matrix. There are some decomposition manners, and “D” is herein defined by formula (14) or formula (15), for example.

$$diag ( \frac{1}{{π}_{1}} , … , \frac{1}{{π}_{K}} ) \qquad ( 14 )$$

$$D = diag ( {G}_{11} , … , {G}_{KK} ) \qquad ( 15 )$$

When assuming that an output probability of a classifier is p(x) and labels y=1, . . . , K, a hybrid loss function is defined by formula (16). Formula (17) defines rᵢ(x) included in formula (16).

$${l}^{hyb} ( y , p ( x ) ) := - {\sum }_{i = 1}^{K} {M}_{yi} log ( \frac{{r}_{i} ( x )}{{\sum }_{j = 1}^{K} {r}_{j} ( x )} ) \qquad ( 16 )$$

$${r}_{i} ( x ) := \frac{{p}_{i} ( x )}{{D}_{ii}} \qquad ( 17 )$$

In a case where a gain matrix G is a diagonal matrix, a hybrid loss function indicated in formula (16) is referred to as a logit-adjustment (LA) loss function. In the conventional technology 1, parameters of a classifier are trained so as to minimize an expectation value E indicated in formula (18) in a case of (x, y)˜D.

E_{(x,y)˜D}[l^{hyb}(y,p(x))] . . . (18)

Subsequently, the conventional technology 2 will be explained. The conventional technology 2 executes semi-supervised learning with the use of labeled training data and unlabeled training data. Assume that labeled training data are {(x_{b}, y_{b}): b=1, . . . , B}. Assume that unlabeled training data are {u_{b} ∈ X: b=1, . . . , μB}.

FIG. 6 is a diagram illustrating the conventional technology 2. In the conventional technology 2, two types of data augmentation are used which are referred to as strong augmentation and weak augmentation.

In FIG. 6, strong augmentation is executed on unlabeled training data Im1 to generate data Im1-1. Weak augmentation is executed on training data Im1 to generate data Im1-2.

In the conventional technology 2, the data Im1-1 are input to a model 10, and then an output probability p1-1 is output from the modal 10. In the conventional technology 2, the data Im1-2 are input to the model 10, and then an output probability p1-2 is output from the model 10. In the conventional technology 2, a pseudo-label 5 is generated on the basis of the output probability p1-2. For example, the Pseudo-label 5 is an output probability in which the maximum component in components of the output probability p1-2 is set at “1” and the other components are set at “0”. In the conventional technology 2, training of the model 10 is executed with the use of a loss function using cross-entropy between the output probability p1-1 and the pseudo-label 5.

in the following explanation, strongly-augmented unlabeled training data are appropriately denoted by A(u_{b}). Weak-augmented unlabeled training data re denoted by α(u_{b}).

In the conventional technology 2, training of the model 10 is executed with the use of a loss function L in formula (19). In formula (19), a loss function lₛ is a loss function for labeled training data. A loss function lᵤ is a loss function for unlabeled training data. λᵤ is set at a value equal to or more than zero.

L=l_{S}+λᵤlᵤ . . . (19)

The loss function 1 is defined by formula (20). In formula (20), y_{b} corresponds to a label that is set for training data. q_{b} is an output probability in weak augmentation, and is defined by “q_{b}=p(α(u_{b}))”. For example, cross-entropy is expressed by H(p₁, p₂) with respect to two probabilities p₁ and p₂. H(y_{b}, q_{b}) is cross-entropy between y_{b} and q_{b}.

$${l}_{s} = \frac{1}{B} {\sum }_{b = 1}^{B} H ( {y}_{b} , {q}_{b} ) \qquad ( 20 )$$

The loss function lᵤ is defined by a difference between an output probability for strong augmentation of unlabeled training data u_{b} and an output probability for weak augmentation of the unlabeled training data u_{b}.

Specifically, the loss function lᵤ is defined by formula (21). q_{b} is an output probability “q_{b}=p(α(u_{b}))” in a case where weakly-augmented unlabeled training data are input to a classifier. “p” is an output probability of the model 10. “q′_{b}” is a one-hot vector where only an argmax(q_{b})-th component is “1”. p(A(u_{b})) is an output probability in a case where strongly-augmented unlabeled training data are input to a classifier.

$${l}_{u} := \frac{1}{μ B} {\sum }_{b = 1}^{μ B} 1 ( max {q}_{b} > τ ) H ( {{q}^{'}}_{b} , p ( 𝒜 ( {u}_{b} ) ) ) \qquad ( 21 )$$

In formula (21), “τ” is a parameter of algorithm. “1 (max q_{b}>τ)” indicates that only training data that provide a reliable predicted label, in an unlabeled training data set, are used for training of the model 10. The predicted label corresponds to the pseudo-label having been explained with reference to FIG. 6.

For example, related arts are disclosed in Narasimhan, H., Menon, A. K.: Training over-parameterized models with non-decomposable objectives, NeurIPS 2021 and Sohn et al., FixMatch: Simplifying Semi-Supervised Learning with Consistency and Confidence, NeurIPS 2020 .

### SUMMARY

According to an aspect of an embodiment, an information processing apparatus includes one or more memories; and one or more processors coupled to the one or more memories, the one or more processors being configured to decide a gain matrix based on an input metric, perform selection of first training data from a plurality of unlabeled training data, to be used for training a machine learning model, based on the gain matrix, and perform training of the machine learning model based on the first training data, a predicted label that is predicted from the first training data, and a loss function including the gain matrix.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a relation between an metric and a gain matrix G.

FIG. 2 is a functional block diagram illustrating a configuration of an information processing apparatus according to a present embodiment.

FIG. 3 is a flowchart (1) illustrating a processing procedure to be executed by the information processing apparatus according to the present embodiment.

FIG. 4 is a flowchart (2) illustrating a processing procedure to be executed by the information processing apparatus according to the present embodiment.

FIG. 5 is a diagram illustrating one example of a hardware configuration of a computer that realizes functions similar to those of the information processing apparatus according to the embodiment.

FIG. 6 is a diagram illustrating a conventional technology 2.

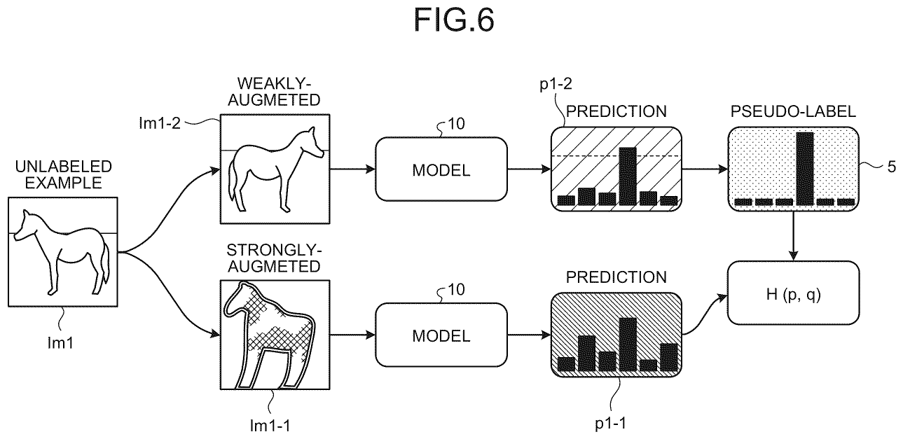

### DESCRIPTION OF EMBODIMENT(S)

For example, if the conventional technology 1 and the conventional technology 2 are simply combined, an metric where optimization is difficult leads to cost-sensitive learning, and then optimization is executed thereon by a method of semi-supervised learning. In this case, training of a classifier is executed by using, in addition to a labeled training data set, training data that provide a reliable predicted label, in an unlabeled training data set. Specifically, unlabeled training data corresponding to qi that satisfies “1 (max q_{b}>τ)” indicated in formula (21) are used.

However, in the technology obtained by simply combining the conventional technology 1 and the conventional technology 2, in an metric where optimization is difficult, most of q_{b} corresponding to unlabeled training data do not satisfy “1 (max q_{b}>τ)”. In other words, an actual problem is that, even in a case where many unlabeled training data corresponding to a predicted label with high reliability are included, most of the unlabeled training data are rarely used for training of a classifier.

Preferred embodiments of the present invention will be explained with reference to accompanying drawings. The present invention is not limited to embodiments described below. Moreover, embodiments may be combined within a consistent range.

An information processing apparatus according to the present embodiment trains a parameter of a classifier (machine learning model) by using a loss function that includes a loss function for labeled training data and a loss function for unlabeled training data.

In the present embodiment, unlabeled training data that provide a reliable predicted label are defined by using a Kullback-Leibler divergence (KL-divergence) in a loss function for unlabeled training data. A KL-divergence indicates a pseudo-distance between two probability distributions that indicates a degree of a similarity between the two probability distributions.

For example, the information processing apparatus selects corresponding unlabeled training data as unlabeled training data that provide a reliable predicted label, in a case where a condition indicated in formula (22) is satisfied. “q_{b}” in formula (22) is an output probability that is an output probability “q_{b}=p(α(u_{b}))” in a case where weak data augmentation is applied to unlabeled. training data and data to which the weak data augmentation has been applied are input to a classifier. D_{KL} indicates a KL-divergence. “τ” is a parameter of algorithm that is set preliminarily.

$${D}_{KL} ( {q}_{b} , {( \frac{{G}_{ý , i}}{{\sum }_{k = 1}^{K} {G}_{ý , k}} )}_{i} ) < τ \qquad ( 22 )$$

In formula (22) , y′ is a predicted label (pseudo-label) that s defined by formula (23).

ý=argmax q_{b}=argmax p(α(u_{b})) . . . (23)

A definition of formula (22) is based on the theory that q_{b} that converges to a value of formula (24).

$${( \frac{{G}_{ý , i}}{{\sum }_{k = 1}^{K} {G}_{ý , k}} )}_{1 \leq i \leq K} \qquad ( 24 )$$

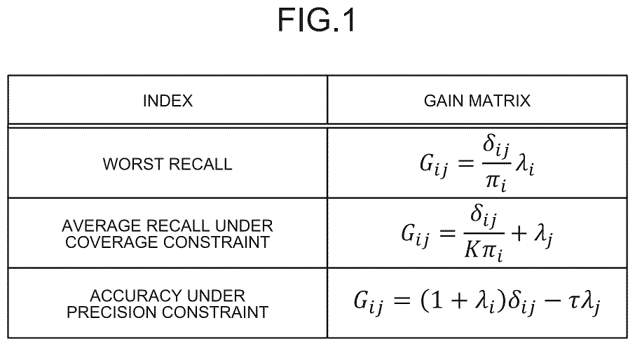

Additionally, the information processing apparatus specifies a definition of a gain matrix G in formula according to a specified metric. The information processing apparatus receives specifying of an metric externally. FIG. 1 is a diagram illustrating a relation between an metric and a gain matrix G. As illustrated in FIG. 1, the information processing apparatus uses, as a gain matrix G, a gain matrix indicated in formula (12) in a case where an metric is “the worst recall”. The information processing apparatus uses, as a gain matrix G, a gain indicated in formula (13) in a case where an metric is “an average recall under a coverage constraint”. The information processing apparatus uses, as a gain matrix G, a gain matrix indicated in formula (25) in a case where an metric is “the accuracy under a precision constraint”.

Gᵢⱼ=(1+λᵢ)δᵢⱼ−τλⱼ . . . (25)

The information processing apparatus trains a parameter of a classifier by using a loss function L′ in formula (26). In a loss function in formula (26), a loss function lₛ is a loss function for labeled training data. A loss function l′ᵤ is a loss function for unlabeled training data. λᵤ is set at a value equal to or more than 0.

L′=l_{S}+λᵤĺᵤ . . . (26)

A loss function lₛ is defined by formula (26a) as mentioned below.

$${l}_{s} = \frac{1}{B} {\sum }_{b = 1}^{B} {l}^{hyb} ( {y}_{b} , {q}_{b} ) \qquad ( 26 a )$$

A loss function l′ᵤ is defined by formula (27). As formula (27) is compared with formula (21), “1 (max q_{b}>τ)” in formula (21) is replaced by a definition that uses a KL-divergence explained in formula (22). Furthermore, in formula (27), a hybrid loss function explained in a formula (16) is used instead of a cross entropy H. q_{b} is an output Probability “q_{b}=p(α(u_{b}))” in a case where unlabeled training data to which weak data augmentation has been applied are input to a classifier. p is an output probability of a classifier. “q′_{b}” indicates a one-hot vector where only an argmax(q_{b})-th component is “1”. p(A(u_{b})) is an output probability in a case where unlabeled training data to which strong data augmentation has been applied are input to a classifier.

$${{l}^{'}}_{u} := \frac{1}{μ B} {\sum }_{b = 1}^{μ B} 1 ( {D}_{KL} ( {q}_{b} , {( \frac{{G}_{ý , i}}{{\sum }_{k = 1}^{K} {G}_{ý , k}} )}_{i} ) < τ ) {l}^{hyb} ( {{q}^{'}}_{b} , p ( 𝒜 ( {u}_{b} ) ) ) \qquad ( 27 )$$

As described above, the information processing apparatus trains a parameter of a classifier on the basis of labeled training data, unlabeled training data, and a gain matrix G according to an metric, in such a manner that a value of a loss function L′ is minimized. Thereby, even for some indices where optimization is difficult, it is possible to execute training of a classifier by appropriately using unlabeled training data that provide a predicted label with high reliability. Indices where optimization is difficult are the worst recall, an average recall under a coverage constraint, a recall under a precision constraint, and the like, as explained in FIG. 1.

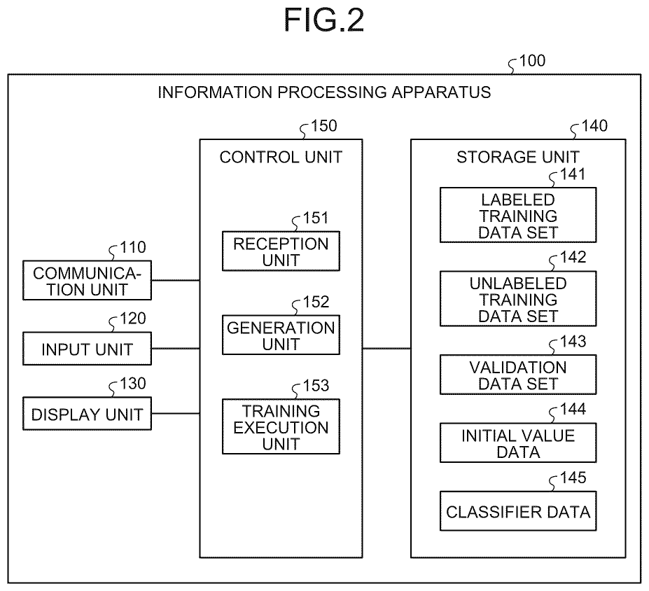

Subsequently, a configuration example of an information processing apparatus according to the present embodiment will be explained. FIG. 2 is a functional block diagram illustrating a configuration of an information processing apparatus according to the present embodiment. As illustrated in FIG. 2, an information processing apparatus 100 includes a communication unit 110, an input unit 120, a display unit 130, a storage unit 140, and a control unit 150.

The communication unit 110 executes data communication with an external device and the like through a network. The communication unit 110 may receive, from an external device, a labeled training data set 141, a unlabeled training data set 142, a validation data set 143, and the like, as mentioned later.

The input unit 120 receives an operation of a user. A user executes specifying of an metric by using the input unit 120.

The display unit 130 displays a processing result of the control unit 150.

The storage unit 140 includes the labeled training data set 141, the unlabeled training data set 142, the validation data set 143, initial value data 144, and classifier data 145. For example, the storage unit 140 is realized by a memory and the like.

The labeled training data set 141 includes a plurality of labeled training data. Labeled training data are composed of a set of input data and a correct answer label. Labeled training data are provided as {(x_{b}, y_{b}): b=1, . . . , B}.

The unlabeled training data set 142 includes a plurality of unlabeled training data. Unlabeled training data include input data and do not include a correct answer label. Unlabeled training data are provided as {u_{b}∈X: b=1, . . . , μB}. A predicted label (pseudo-label) for unlabeled training data are generated by the control unit 150 be mentioned later.

The validation data set 143 includes a plurality of validation data. Validation data are composed of a set of input data and a correct answer label. The validation data set 143 is used in a case where a confusion matrix is estimated.

The initial value data 144 include an iteration number T, a learning rate ω, and the like. An iteration number T and a learning rate are used in a case where a classifier is trained.

The classifier data 145 are data of a classifier F that are a target for training. For example, a classifier F is a Neural Network (NN).

The control unit 150 includes a reception unit 151, a generation unit 152, and a training execution unit 153. For example, the control unit 150 is realized by a processor.

The reception unit 151 receives an input of an metric from the input unit 120. For example, an metric that is received by the reception unit 151 is the worst recall, an average recall under a coverage constraint, a recall under a precision constraint, and the like. The reception unit 151 outputs a received metric to the training execution unit 153.

The generation unit 152 executes strong data augmentation on unlabeled training data u_{b} so as to generate training data A(u_{b}). The generation unit 152 executes weak data augmentation on unlabeled training data so as to generate training data α(u_{b}).

The generation unit 152 reads the classifier data 145 and inputs training data α(u_{b}) to a classifier F so as to calculate an output probability q_{b}. An output probability q_{b} is defined as “q_{b}=p(α(u_{b}))”. Furthermore, the generation unit 152 calculates formula (23) as mentioned above so as to calculate a predicted label y′ for unlabeled training data.

The generation unit 152 outputs unlabeled training data u_{b}, training data A(u_{b}), training data α(u_{b}), an output probability q_{b}, and a predicted label y′ to the training execution unit 153.

The generation unit 152 repeatedly executes the process as mentioned above on each of unlabeled training data that are included in the unlabeled training data set 142. Additionally, such a process of the generation unit 152 may be executed by the training execution unit 153 as mentioned later.

The training execution unit 153 selects unlabeled training data that are used for training of a classifier F, from unlabeled training data u_{b}, on the basis of a gain matrix according to a specified metric. For example, the training execution unit 153 selects a plurality of unlabeled training data that satisfy a condition of formula (22).

The training execution unit 153 trains a parameter of a classifier F on the basis of a selected plurality of unlabeled training data, a predicted label that corresponds to such unlabeled training data, the labeled training data set 141, and a loss function L′, in such a manner that a value of a loss function L′ is minimized. A loss function L′ is indicated in formula (26) as mentioned above.

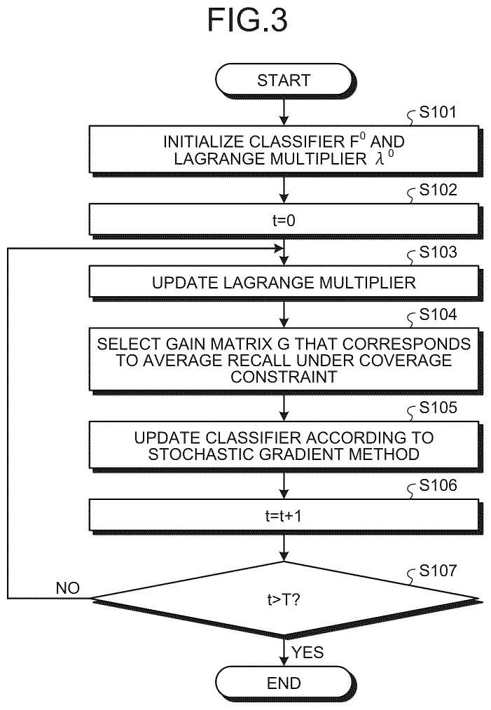

Herein, one example of a processing procedure of the training execution unit 153 in a case where “an average recall under a coverage constraint” is specified as an metric will be explained. FIG. 3 is a flowchart (1) illustrating a processing procedure of the information processing apparatus according to the present embodiment. In an explanation of FIG. 3, labeled training data are denoted by “S_{S}”. Unlabeled training data are denoted by “Sᵤ”. Validation data are denoted by “Sᵥₐₗ”. An iteration number is denoted by “T”. A learning rate is denoted by “ω”.

As illustrated in. FIG. 3, the training execution unit 153 of the information processing apparatus 100 initializes a classifier F₀ and a Lagrange multiplier λ₀ (step S101). Additionally, λ⁰ is a K-dimensional vector with non-negative entries. The training execution unit 153 sets t=0 (step S102).

The training execution unit 153 updates a Lagrange multiplier (step S103). At step S103, the training execution unit 153 executes a next process. The training execution unit 153 estimates a confusion matrix C′(F^{t}) by using the validation data set 143 Specifically, the training execution unit 153 estimates a confusion matrix C′(F^{t}) on the basis of formula (28). In formula (28), |Sᵥₐₗ| is the number of validation data that are included in the validation data set 143.

$${{C}^{'}}_{ij} ( {F}^{t} ) = \frac{1}{\vert {S}_{val} \vert} {\sum }_{( x , y ) ∈ {S}_{val}} 1 ( y = i , {F}^{t} ( x ) = j ) \qquad ( 28 )$$

The training execution unit 153 calculates a Lagrange multiplier λ^{t+1} on the basis of formula (29). Furthermore, the training execution unit 153 calculates a Lagrange multiplier λ^{t+1} on the basis of formula (29), and subsequently, specifies a value of the Lagrange multiplier λ^{t+1} on the basis of formula (30).

λᵢ^{t+1}=λᵢ^{t}−ω(Σₖ₌₁^{K}Ć_{kí}(F^{t})−0.95 πᵢ) . . . (29)

An explanation of step 5104 will be shifted to. The training execution unit 153 selects a gain matrix G that corresponds to an average recall under a coverage constraint (step S104). A gain matrix G that corresponds to an average recall under a coverage constraint is indicated in formula (31).

$${G}_{ij} = \frac{{δ}_{ij}}{K {π}_{i}} {λ}_{j}^{t + 1} \qquad ( 31 )$$

The training execution unit 153 updates a classifier F according to a stochastic gradient method (step S105). At step S105, the training execution unit 153 samples batches B_{S}, Bᵤ from S_{S}, Sᵤ, respectively. The training execution unit 153 updates a parameter of a classifier F^{t} according to a stochastic gradient method on the basis of batches B_{S}, Bᵤ and a gain matrix in formula (31), in such a manner that a loss function L′ that is defined by formula (26) is minimized, and provides a classifier after updating as a classifier F^{t+1}.

The training execution unit 153 updates t according to t=t+1 (step S106). The training execution unit 153 is shifted to step S103 in a case where a condition of t>T is not satisfied (step S107, No). On the other hand, the training execution unit 153 ends such a process in a case where a condition of t>T is satisfied (step S107, Yes).

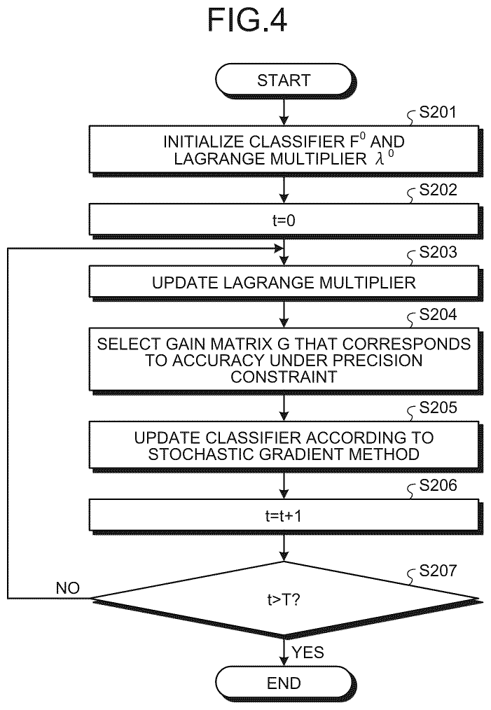

Subsequently, one example of a processing procedure of the training execution unit 153 in a case where “the accuracy under a precision constraint” is specified as an metric will be explained. FIG. 4 is a flowchart (2) illustrating a processing procedure of the information process rig apparatus according to the present embodiment. In an explanation of FIG. 4, labeled training data are denoted by “S_{S}”. Unlabeled training data are denoted by “Sᵤ”. Validation data are denoted by “Sᵥₐₗ”. An iteration number is denoted by “T”. A learning rate is denoted by “ω”.

As illustrated in FIG. 4, the training execution. unit 153 of the information processing apparatus 100 initializes a classifier F⁰ and a Lagrange multiplier λ⁰ (step S201). Additionally, λ⁰ is a K-dimensional vector with non-negative entries. The training execution unit 153 sets t=0 (step S202).

The training execution unit 153 updates a Lagrange multiplier (step S203). A process at step S203 is similar to the process at step S103 in FIG. 3.

The training execution unit 153 selects a gain matrix G that corresponds to the accuracy under a precision constraint (step S204). A gain matrix G that corresponds to the accuracy under a precision constraint is indicated in formula (32).

Gᵢⱼ=(1+λᵢ^{t+1})δᵢⱼ−τλⱼ^{t+1} . . . (32)

The training execution unit 153 updates a classifier F according to a stochastic gradient method (step S205). A process at step S205 is similar to the process at step S105 in FIG. 3.

The training execution unit 153 updates t according to t=T (step S206). The training execution unit 153 is shifted to step S203 in a case where a condition of t>T is not satisfied (step S207, No). On the other hand, the training execution unit 153 ends such a process in a case where a condition of t>T is satisfied (step S207, Yes).

Next, effects of the information processing apparatus 100 according to the present embodiment will be explained The information processing apparatus 100 defines unlabeled training data that provide a reliable predicted label by using a KL-divergence, selects a gain matrix according to an input metric, and selects unlabeled training data that provide a predicted label with high. reliability. The information processing apparatus 100 trains a parameter of a classifier, on the basis of labeled training data, selected unlabeled training data, and a loss function lid that includes a gain matrix P according to an metric, in such a manner that a value of the loss function L′ is minimized. Thereby, even for some indices where optimization is difficult, it is possible to execute training of a classifier F by appropriately using unlabeled training data that provide a predicted label with high reliability.

The information processing apparatus 100 executes data augmentation on unlabeled training data, and selects corresponding unlabeled training data in a case where a pseudo-distance between a distribution of an output probability that is output when augmented data are input to a classifier and a probability distribution that is based on a gain matrix is equal to or less than a threshold. Thereby, it is possible to appropriately use unlabeled training data that provide a predicted label with high reliability.

The information processing apparatus 100 inputs training data α(u_{b}) to which weak data augmentation has been applied to a classifier F so as to calculate an output probability q_{b}, and calculates a predicted label y′ on tLle basis of the output probability q_{b}. Thereby, it is possible to set a predicted label for unlabeled training data and use it for training.

The information processing apparatus 100 trains a classifier F on the basis of a value obtained by inputting, to a hybrid loss function, q_{b} that is an output probability in a case where unlabeled training data to which weak data augmentation has been applied are input to a classifier F and p(A(u_{b})) that indicates an output probability in a case where unlabeled training data to which strong data. augmentation has been applied are input to the classifier F. That is, it is possible to train a classifier F by using unlabeled data.

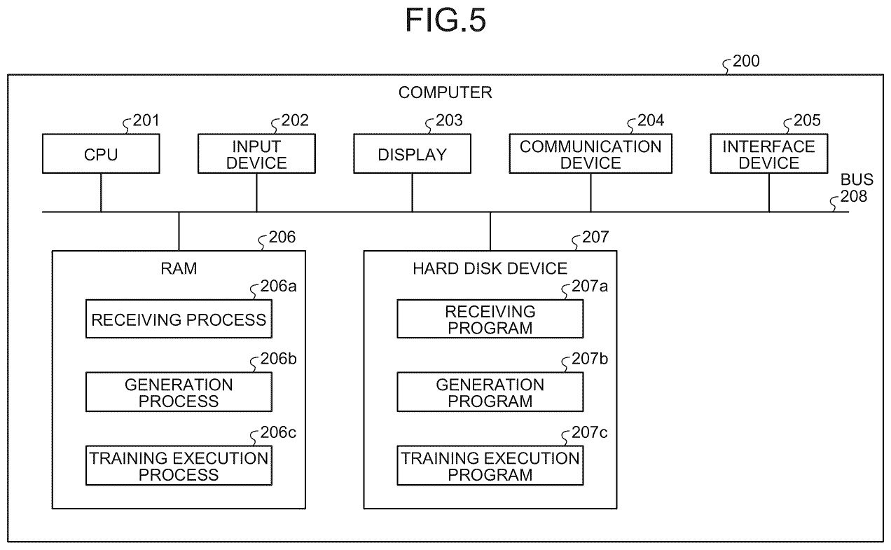

Next, one example of a hardware configuration of a computer that realizes functions similar to those of the information processing apparatus 100 disclosed in the above-mentioned embodiment will be explained. FIG. 5 is a diagram illustrating one example of a hardware configuration of a computer that realizes functions similar to those of the information processing apparatus according to the embodiment.

As illustrated in FIG. 5, a computer 200 includes a Central Processing Unit (CPU) 201 that executes various operation processes, an input device 202 that receives an input of data from a user, and a display 203. The computer 200 includes a communication device 204 that transmits/receives data to/from an external device and the like via a wired or wireless network, and an interface device 205. The computer 200 further includes a Random. Access Memory (RAM) 206 that temporarily stores therein various kinds of information and a hard disk device 207. The devices 201 to 207 are connected to a bus 208.

The hard disk device 207 includes a receiving program 207a, a generation program 207b, and a training execution program 207c. The CPU 201 reads out each of the programs 207a to 207c, and deploys the read one in the RAM 206.

The receiving program 207a functions as a receiving process 206a. The generation program 207b functions as a generation process 206b. The training execution program 207c functions as a training execution process 206c.

The receiving process 206a corresponds to a process to be executed by the reception unit 151. The generation process 206b corresponds to a process to be executed by the generation unit 152. The training execution process 206c corresponds to a process to be executed by the training execution unit 153.

The programs 207a to 207c are not necessarily stored in the hard disk device 207 in advance. For example, each of the programs may be stored in a “physical medium” such as a flexible disk (FD), a Compact Disc Read Only Memory (CD-ROM) , a Digital Versatile Disc (DVD) , a magneto-optical disc, and an Integrated Circuit card (IC card), which are inserted into the computer 200. The computer 200 may read therefrom and execute each of the programs 207a to 207c.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
one or more memories; and
one or more processors coupled to the one or more memories, the one or more processors being configured to
decide a gain matrix based on an input metric,
perform selection of first training data from a plurality of unlabeled training data, to be used for training a machine learning model, based on the gain matrix, and
perform training of the machine learning model based on the first training data, a predicted label that is predicted from the first training data, and a loss function including the gain matrix.

2. The information processing apparatus according to claim 1, wherein the selection includes selecting the first training data in a case where a pseudo-distance between a probability distribution output from the machine learning model in response to inputting data obtained by augmenting the first training data into the machine learning model and a probability distribution that is based on the gain matrix is equal to or less than a threshold.

3. The information processing apparatus according to claim 1, wherein the processors is further configured to generate the predicted label based on an output result from the machine learning model response to inputting first data into the machine learning model, the first data being generated by executing data augmentation with a first intensity on the first training data.

4. The information processing apparatus according to claim 3, wherein the training is executed by inputting a first value and a second value to the loss function, the first value being an output result from the machine learning model in response to inputting second data generated by executing data augmentation with the second intensity on the first training data into the machine learning model, the second intensity being larger than the first intensity, the second value being obtained by vectorizing an output result from the machine learning model in response to inputting the first data into the machine learning model.

5. A computer-implemented machine learning method comprising:
deciding a gain matrix based on an input metric;
selecting, from a plurality of unlabeled training data, first training data to be used for training of a machine learning model, based on the gain matrix; and
training the machine learning model based on the first training data, a predicted label that is predicted from the first training data, and a loss function including the gain matrix.

6. The computer-implemented machine learning method according to claim 5, wherein
the selecting includes selecting the first training data in a case where a pseudo-distance between a probability distribution output from the machine learning model in response to inputting data obtained by augmenting the first training data into the machine learning model and a probability distribution that is based on the gain matrix is equal to or less than a threshold.

7. The computer-implemented machine learning method apparatus according to claim 5, further comprising:
executing data augmentation with a first intensity on the first training data; and
generating the predicted label based on an output result from the machine learning model in response to inputting first data into the machine learning model, the first data being generated by executing data augmentation with the first intensity on the first training data.

8. The computer-implemented machine learning method according to claim 7, wherein
the training is executed by inputting a first value and a second value to the loss function, the first value being an output result from the machine learning model response to inputting the second data generated by executing data augmentation with the second intensity on the first training data, the second intensity being larger than the first intensity, the second value being obtained by vectorizing an output result from the machine learning model in response to inputting the first data into the machine learning model.

9. A non-transitory computer-readable recording medium having stored therein machine learning program that causes a computer to execute a process comprising:
deciding a gain matrix based on an input metric;
selecting, from a plurality of unlabeled training data, first training data to be used for training of a machine learning model, based on the gain matrix; and
training the machine learning model based on the first training data, a predicted label that is predicted from the first training data, and a loss function including the gain matrix.

10. The non-transitory computer-readable recording medium according to claim 10, wherein
the selecting includes selecting the first training data in a case where a pseudo-distance between a probability distribution output from the machine learning model in response to inputting data obtained by augmenting the first training data into the machine learning model and a probability distribution that is based on the gain matrix is equal to or less than a threshold.

11. The non-transitory computer-readable recording medium according to claim 9, the process including
executing data augmentation with a first intensity on the first training data; and
generating the predicted label based on an output result from the machine learning model in response to inputting first data into the machine learning model, the first data being generated by executing data augmentation with the first intensity on the first training data.

12. The non-transitory computer-readable recording medium according to claim 11, wherein
the training is executed by inputting a first value and a second value to the loss function, the first value being an output result from the machine learning model in response to inputting the second data generated by executing data augmentation with the second intensity on the first training data, the second intensity being larger than the first intensity, the second value being obtained by vectorizing an output result from the machine learning model in response to inputting the first data into the machine learning model.
